(19) United States
(12) Patent Application Publication
(10) Pub. No.: US 2025/0370153 A1
(43) Pub. Date: Dec. 4, 2025

(54) SYSTEM AND METHODS OF SELECTING MEASUREMENT CHANNELS

(71) Applicant: Schlumberger Technology Corporation, Sugar Land, TX (US)

(72) Inventors: Xiaoyan Zhong, Sugar Land, TX (US); Keli Sun, Sugar Land, TX (US); Kent Harms, Richmond, TX (US)

(21) Appl. No.: 18/680,801

(22) Filed: May 31, 2024

(51) Int. Cl. G01V 1/50; G01V 1/46

(52) U.S. Cl. CPC G01V 1/50; G01V 1/46

(57) ABSTRACT

The present disclosure provides systems and methods of selecting measurement channels. The methods include receiving a plurality of measurement channels for a logging tool. A plurality of measurement parameters is determined for each measurement channel of the plurality of measurement channels of a formation of a wellbore. A global sensitivity indices is determined, in which determining the global sensitivity indices includes identifying a sampling distribution of the plurality of measurement parameters using a measurement parameter range for each measurement parameter, receiving a noise model, and determining the global sensitivity indices using the measurement parameters, the sampling distribution, and the noise model. Each measurement channel of the plurality of measurement channel is ranked using the global sensitivity indices.

### BACKGROUND

Various logging techniques may be used to survey oil or gas wells to determine their petrophysical or geophysical properties using various electronic measuring instruments. For example, wireline logging techniques, e.g., electronic measuring instruments secured to a wireline cable, measurement while-drilling (“MWD”) techniques, e.g., electronic measuring instruments secured to the drilling assembly that measure the downhole conditions and movement of the drilling assembly, or logging while-drilling (“LWD”) techniques, e.g., electronic measuring instruments secured to the drilling assembly that measure measurement of formation parameters, have been implemented to collect formation and/or borehole information, as well as data on movement and placement of the drilling assembly.

Unfortunately, each of the logging techniques, can provide more than 1000 data channels generated by different combinations of multiple triaxial transmitters and receivers from different spacings and frequencies, thereby limiting data analysis due to reduced bandwidth during telemetry while drilling real time. Moreover, currently each of the logging techniques review more than 1000 data channels, with limited and/or no way to differentiate the most sensitive channels from the least sensitive channels, thereby reducing the quality of the inversion results obtained from the logging techniques.

Accordingly, improved methods of logging techniques are needed.

### SUMMARY

The present disclosure provides methods of ranking measurement channels. The methods include receiving a plurality of measurement channels for a logging tool. A plurality of measurement parameters is determined for each measurement channel of the plurality of measurement channels of a formation of a wellbore. A global sensitivity indices is determined, in which determining the global sensitivity indices includes identifying a sampling distribution of the plurality of measurement parameters using a measurement parameter range for each measurement parameter, receiving a noise model, and determining the global sensitivity indices using the measurement parameters, the sampling distribution, and the noise model. Each measurement channel of the plurality of measurement channel is ranked using the global sensitivity indices.

The present disclosure also provides methods of selecting measurement channels. The methods include receiving a plurality of measurement channels for a logging tool. A plurality of measurement parameters is determined for each measurement channel of the plurality of measurement channels of a formation of a wellbore. A global sensitivity indices is determined using the plurality of measurement parameters and a sampling distribution. Each measurement channel of the plurality of measurement channel is ranked using the global sensitivity indices. At least a portion of the plurality of measurement channels is selected, in which selecting the at least a portion of the plurality of measurement channels includes receiving a selection threshold, and selecting the at least a portion of the plurality of measurement channels based on the selection threshold.

The present disclosure also provides systems. The systems include one or more processors, memory operatively coupled to the one or more processors, and processor-executable instructions stored in the memory and executable by at least one of the processors to instruct the system to receive a plurality of measurement channels for a logging tool. A plurality of measurement parameters is determined for each measurement channel of the plurality of measurement channels of a formation of a wellbore. A global sensitivity indices is determined, in which determining the global sensitivity indices includes identifying a sampling distribution of the plurality of measurement parameters using a measurement parameter range for each measurement parameter, receiving a noise model, and determining the global sensitivity indices using the measurement parameters, the sampling distribution, and the noise model. Each measurement channel of the plurality of measurement channel is ranked using the global sensitivity indices.

The following description and the appended figures set forth certain features for purposes of illustration.

### BRIEF DESCRIPTION OF DRAWINGS

So that the manner where the above recited features may be understood in detail, a more particular description, briefly summarized above, may be had by reference to example aspects, some of which are illustrated in the appended drawings.

FIG. 1 depicts a diagrammatic representation of a system according to one or more embodiments disclosed herein.

FIGS. 2A and 2B depict a diagrammatic representations of a three-layer formation according to one or more embodiments disclosed herein.

FIG. 3 depicts a diagrammatic representation of method of ranking a plurality of measurement channels according to one or more embodiments disclosed.

FIG. 4 depicts a diagrammatic representation of a method of ranking a plurality of measurement channels according to one or more embodiments disclosed.

FIG. 5 depicts a diagrammatic representation of a first measurement channel selection process according to one or more embodiments disclosed.

FIG. 6 depicts a diagrammatic representation of a second measurement channel selection process according to one or more embodiments disclosed.

FIG. 7 depicts a diagrammatic representation of a third measurement channel selection process according to one or more embodiments disclosed.

FIGS. 8A-8E depict graphical representations local sensitivity indices and global sensitivity indices according to one or more embodiments disclosed.

FIGS. 9A-9E depict graphical representations local sensitivity indices and global sensitivity indices according to one or more embodiments disclosed.

FIG. 10 depicts a graphical representation of a global sensitivity indices of a measurement channel according to one or more embodiments disclosed.

FIGS. 11A and 11B depicts a table of a ranked plurality of measurement channels according to one or more embodiments disclosed.

### DETAILED DESCRIPTION

One or more specific embodiments of the present disclosure will be described herein. These described embodiments are only examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The present disclosure relates to systems and methods of selecting measurement channels. The present disclosure can increase the rate of telemetry using local sensitivity indices and/or global sensitivity indices to restrict the total number of measurement channels that are sent and/or processed, thereby increasing the speed of signal transfer from the measurement tool to the computing system. Moreover, the measurement channels that are transmitted to the computing system may be ranked and/or selected using the local sensitivity indices and/or global sensitivity indices to provide increased sensitivity and/or resolution, thereby increasing the quality of the mapping of the formation. Additionally, the present disclosure allows for the ranking and/or selection of measurement channels during drilling, thereby allowing for real-time and/or rapid channel selection, e.g., milliseconds to seconds, when encountering formations in a wellbore, thereby increasing efficiency of wellbore drilling.

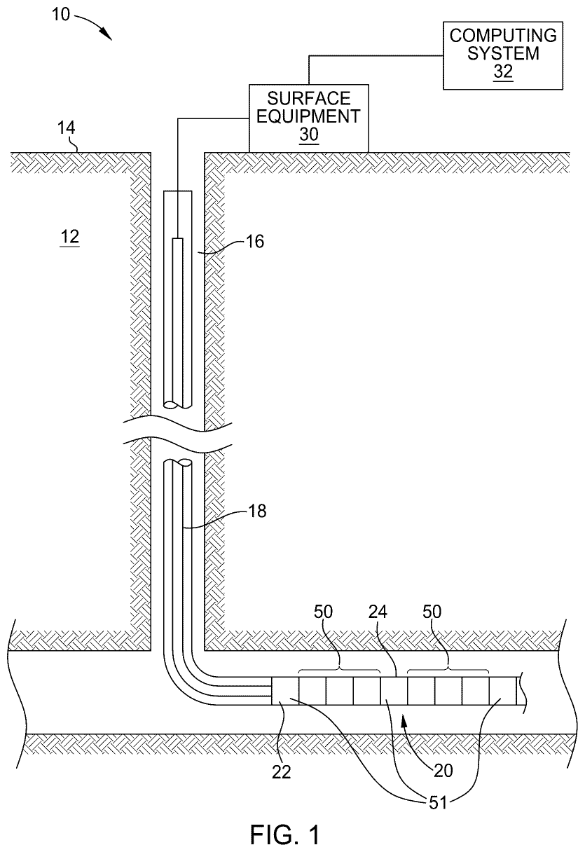

FIG. 1 depicts an embodiment of a system 10 for selecting a measurement channel. The system 10 can be onshore or offshore. In some embodiments, as depicted in FIG. 1, the system 10 includes a subterranean region 12 beneath a ground surface 14, for example, when a drill site is located onshore. The subterranean region 12 can include one or more subsurface layers, such as, for example, sedimentary layers, rock layers, or the like. In some embodiments, the subterranean region 12 can include one or more subterranean formations below a seabed, for example, when a drill site is located offshore. The subterranean region 12 includes a borehole 16 that penetrates the subterranean region 12. The borehole 16 can be adapted for use in connection with a vertical well, horizontal well, slanted well, curved well, or any combination of such wells. The system 10 includes a drill string 18 that extends into the borehole 16 and includes a bottomhole assembly 20 (BHA), a drill bit (not shown), and a logging tool 22 suitable for making downhole logging measurements. The drill string 18 may further include other suitable downhole tool components, such as, a rotary steerable tool, downhole telemetry system, and one or more MWD or LWD tools including various sensors for sensing downhole characteristics of the borehole 16 and the surrounding formations.

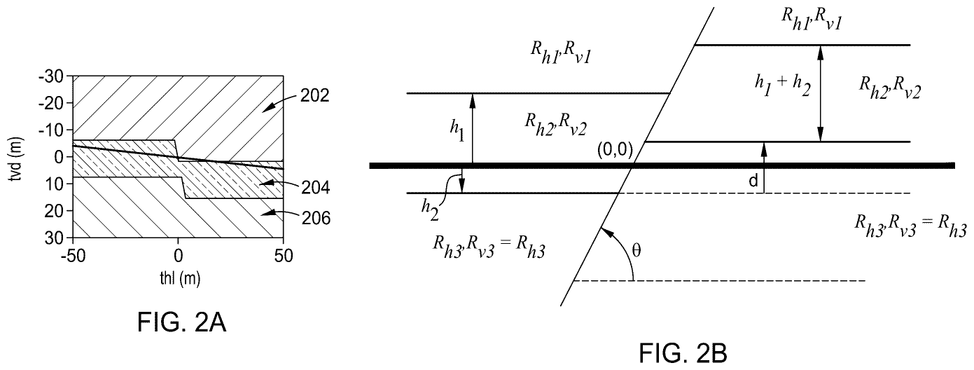

The logging tool 22 includes a resistivity array 24. The resistivity array 24 can include any number of transmitters 50, as shown in FIG. 1, and any number of receivers 51, as shown in FIG. 1. For example, in the logging tool 22 depicted in FIG. 1, the resistivity array 24 includes a plurality of transmitters and receivers spaced apart axially along a body of the logging tool 22. The transmitters 50 and receivers 51 can include axial, trixial, tilted, and transverse antennas. Application of a time varying electric current in the transmitter 50 antennas produces a corresponding time varying magnetic field in the formation. The magnetic field in turn induces eddy currents in the conductive formation. These eddy currents further produce secondary magnetic fields which may produce a voltage response in one or more of the receiver 51 antennas. The measured voltage can be processed to obtain one or more measurements of the secondary magnetic field, which may in turn be further processed to estimate various formation properties such as resistivity, resistivity anisotropy, distance to a remote bed, apparent dip angle, dip azimuth angle, or the like as described below in FIG. 2, collectively referred to herein as well log data, through a corresponding measurement channel. For example, transmitters 50 can generate electromagnetic waves at select frequencies that are received by the receivers 51 after travelling through the formation. An amplitude and a phase difference between the electromagnetic wave can be measured and a resistivity measurement derived for a particular depth, in addition to various other attenuation measurements. The well log data can therefore include phase-shift, amplitudes, and attenuation data obtained from various transmitter-receiver pairs and at multiple frequencies.

The system 10 further includes surface equipment 30 that can include various components that are operatively coupled to the logging tool 22. For example, the surface equipment 30 may include a controller that controls the operation of the logging tool 22 and the acquisition of the well log data. The logging tool 22 and the surface equipment 30 can be communicatively coupled to a computing system 32. For example, the system 10 can include communication or telemetry equipment to communicate or transmit the well log data to the computing system 32. The communication or telemetry equipment may be communicatively coupled to the computing system 32 via one or more communication channels such as a wire based network, wireless network, or combination of networks.

The computing system 32 is configured to process the acquired well log data. The computing system 32 can include a memory, a processor, and input/output controllers communicatively coupled to the processor via a communication bus. The memory can include one or more volatile storage devices, for instance random access memory (RAM), and one or more non-volatile storage devices, for instance read only memory (ROM), Flash memory, magnetic hard disk (HDD), optical disk, solid state disk (SSD), and the like. The input/output controllers can be coupled to input/output devices, such as a monitor, a mouse, a keyboard, or the like and to the communication or telemetry equipment. The input/output devices are configured to receive and transmit data in analog or digital form over communication channels. The memory can store instructions associated with an operating system, computer applications, and other resources. The computer applications can include software applications, scripts, functions executables, or other modules that are interpreted or executed by the processor. In particular, the processor can execute instructions to generate output data based on input data, such as the well log data.

In some embodiments, a formation 200 can include a three-layer formation as shown in FIG. 2A. In some embodiments, the formation 200 can include a wellbore having an inclination angle of about 800 to about 100°, e.g., about 800 to about 95°, about 850 to about 90°, or about 840 to about 86°. For example, the formation 200 can include a first layer 202, e.g., shale, a second layer 204, e.g., oil, and a third layer 206, e.g., water. In some embodiments, a fault 208 in the first layer 202, second layer 204, and third layer 206 can be present. The three-layer formation can include a plurality of measurement parameters, as shown in FIG. 2B. In some embodiments, a measurement parameter can include a horizontal resistivity, Rₕ₁, of the first layer 202. In some embodiments, Rₕ₁, can include a range of about 1 ohm*meters (ohm·m) to about 3 ohm·m, e.g., about 1 ohm·m to about 2.8 ohm·m, about 1.3 ohm·m to about 2.5 ohm·m, or about 1.5 ohm·m to about 2.3 ohm·m. In some embodiments, a measurement parameter can include a horizontal resistivity, Rₕ₂, of the second layer 204. In some embodiments, Rₕ₂, can include a range of about 25 ohm*meters (ohm·m) to about 100 ohm·m, e.g., about 30 ohm·m to about 80 ohm·m, about 40 ohm·m to about 70 ohm·m, or about 50 ohm·m to about 60 ohm·m. In some embodiments, a measurement parameter can include a horizontal resistivity, Rₕ₃, of the third layer 206. In some embodiments, Rₕ₃, can include a range of about 0.2 ohm*meters (ohm·m) to about 1 ohm·m, e.g., about 0.2 ohm·m to about 0.8 ohm·m, about 0.3 ohm·m to about 0.7 ohm·m, or about 0.4 ohm·m to about 0.6 ohm·m.

In some embodiments, a measurement parameter can include an anisotropy ratio of the first layer 202, e.g., Rᵥ₁/Rₕ₁, where “Rᵥ₁” is the vertical resistivity of the first layer 202. In some embodiments, the anisotropy ratio of the first layer 202, e.g., Rᵥ₁/Rₕ₁, can be about 2 to about to about 5, e.g., about 2 to about 4, about 2.5 to about 3.5, or about 2.8 to about 3.3. In some embodiments, a measurement parameter can include an anisotropy ratio of the second layer 204, e.g., Rᵥ₂/Rₕ₂, where “Rᵥ₂” is the vertical resistivity of the second layer 204. In some embodiments, the anisotropy ratio of the second layer 204, e.g., Rᵥ₂/Rₕ₂, can be about 1 to about to about 5, e.g., about 1 to about 4, about 1.5 to about 3.5, or about 2 to about 3.3.

In some embodiments, a measurement parameter can include a fault angle, θ, where the fault angle is the angle between the fault plane and the horizontal plane. In some embodiments, the fault angle, θ, can be about 70° to about 110°, e.g., about 70° to about 105°, about 800 to about 105°, or about 900 to about 105°. In some embodiments, a measurement parameter can include a vertical offset, d. In some embodiments, the vertical offset, d, can include a distance of about −15.24 meters (m) to about 15.24 m, e.g., about −15 m to about 10 m, about −10 m to about 10 m, or about −10 m to about 5 m. In some embodiments, the vertical offset, d, can include a distance of about −50 feet (ft) to about 50 ft, e.g., about −50 ft to about 40 ft, about −40 ft to about 40 ft, or about −40 ft to about 5 ft.

In some embodiments, a measurement parameter can include a wellbore to first layer 202 distance, h₁, of about 3.048 m to about 9.144 m, e.g., about 3.5 m to about 9 m, about 4 m to about 8 m, about 5 m to about 8 m, or about 6 m to about 8 m. In some embodiments, the wellbore to first layer 202 distance, h₁, can be about 10 ft to about 30 ft, e.g., about 10 ft to about 25 ft, about 15 ft to about 25 ft, or about 20 ft to about 25 ft. In some embodiments, a measurement parameter can include a wellbore to third layer 206 distance, h₂, of about 3.048 m to about 9.144 m, e.g., about 3.5 m to about 9 m, about 4 m to about 8 m, about 5 m to about 8 m, or about 6 m to about 8 m. In some embodiments, the wellbore to third layer 206 distance, h₂, can be about 10 ft to about 30 ft, e.g., about 10 ft to about 25 ft, about 15 ft to about 25 ft, or about 20 ft to about 25 ft.

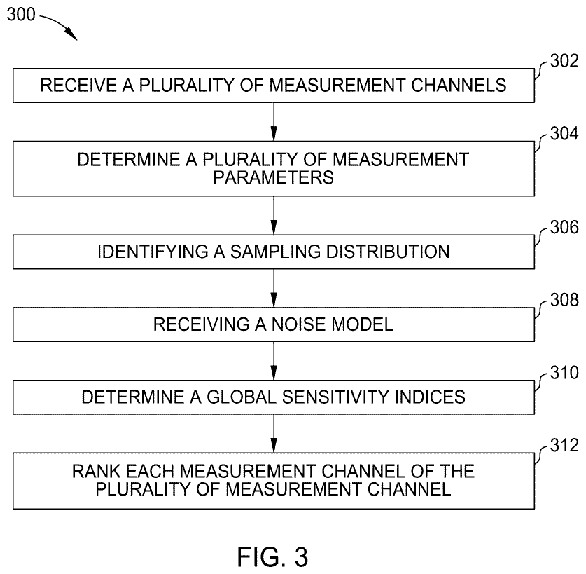

Now referring to FIG. 3, a method 300 of ranking a plurality of measurement channels is shown. At operation 302, a computing system 32 receives a plurality of measurement channels from a logging tool. In some embodiments, the plurality of measurement channels can include about 100 measurement channels to about 2,000 measurement channels, e.g., about 500 measurement channels to about 1800 measurement channels, about 1,000 measurement channels to about 1500 measurement channels, or about 1,200 measurement channels to about 1,400 measurement channels. In some embodiments, the measurement channels can include a combination of shallow, medium, and deep measurement spacing channels. In some embodiments, the plurality of measurement channels is based on the logging tool. For example, a MWD logging technique incorporating tilted and/or transverse antennas capable of providing deep directional resistivities, e.g., PERISCOPE™ and/or GEOSPHERE™ provided by Schlumberger of Houston, TX, can provide about 100 measurement channels to about 100,000 measurement channels.

At operation 304, the computing system 32 determines a plurality of measurement parameters for each measurement channel of the plurality of measurement channels. The plurality of measurement parameters can include one or more of the horizontal resistivity, Rₕ₁, of the first layer 202, the horizontal resistivity, Rₕ₂, of the second layer 204, the horizontal resistivity, Rₕ₃, of the third layer 206, the anisotropy ratio of the first layer 202, e.g., Rᵥ₁/Rₕ₁, the anisotropy ratio of the second layer 204, e.g., Rᵥ₂/Rₕ₂, the fault angle, θ, the vertical offset, d, the wellbore to first layer 202 distance, h₁, and/or the wellbore to third layer 206 distance, h₂. In some embodiments, the computing system 32 can determine each of the horizontal resistivity, Rₕ₁, of the first layer 202, the horizontal resistivity, Rₕ₂, of the second layer 204, the horizontal resistivity, Rₕ₃, of the third layer 206, the anisotropy ratio of the first layer 202, e.g., Rᵥ₁/Rₕ₁, the anisotropy ratio of the second layer 204, e.g., Rᵥ₂/Rₕ₂, the fault angle, θ, the vertical offset, d, the wellbore to first layer 202 distance, h₁, and/or the wellbore to third layer 206 distance, h₂, for each measurement channel of the plurality of measurement channels. For example, the computing system 32 can determine an Rₕ₁ of about 1.0 ohm·m, an Rₕ₂ of about 58.58 ohm·m, an Rₕ₃ of about 0.65 ohm·m, an Rᵥ₁/Rₕ₁ of about 3.13, an Rᵥ₂/Rₕ₂ of about 2.95, a θ of about 103.7, a d of about −7.87 m, an h₁ of about 6.63 m, and an h₂ of about 7.30 m.

At operation 306 a sampling distribution of the plurality of measurement parameters is identified. The sampling distribution is identified using the measurement parameter range for each measurement parameter. For example, the sampling distribution can be identified based on one or more samples in the parameter space, e.g., measurement parameter range. In some embodiments, the sampling distribution can be identified using the Saltelli sampling method to generate samples in the parameter space. For example, the sampling distribution can be identified using the Saltelli sampling method such that about 10,000 sample points to about 30,000 sample points, e.g., about 10,000 sampling points to about 25,000 sampling points, about 15,000 sampling points to about 23,000 sampling points, or about 20,000 sampling points to about 21,000 sampling points, can be identified within the measurement parameter range. Without being bound by theory, the sampling distribution can provide enhanced sensitivity analysis due to the close and/or nearby sampling points, thereby allowing local sensitivity of each measurement parameter to be determined. Moreover, the sampling distribution can identify local parameter variations, e.g., variations in each measurement parameter of the plurality of measurement parameters relative to the same measurement parameter, and/or global parameter changes, e.g., variations in each measurement parameter of the plurality of measurement parameters relative to the alternative measurement parameters.

At operation 308, the computing system 32 receives a noise model. The noise model can indicate one or more realistic noise and/or systematic errors corresponding to the logging tool. For example, the realistic noise can include electronic noise, fluctuation-induced noise, receiver tool face angle measurement noise, transmitter-receiver alignment angle noise, and a combination thereof. As a further example, the systematic errors can include gain mismatch, title angle, alignment angle and bending, and a combination thereof. In some embodiments, the realistic noise and systematic errors can be received based on the acquired well log data, lab measurements, and/or one or more simulations which can apply an error distribution model. The error distribution model may apply a random generation of errors to determine the error distribution. The error distribution model can be defined by various mathematical functions and algorithms, such as Gaussian error assumption, homogenous error assumption, Laplacian error assumption, or combinations thereof.

At operation 310, a global sensitivity indices is determined using the measurement parameters, the sampling distribution, and the noise model. The global sensitivity indices can calculate the sensitivity of the measurement parameter based on both the local parameter variations, e.g., variations in each measurement parameter of the plurality of measurement parameters relative to the same measurement parameter, and/or global parameter changes, e.g., variations in each measurement parameter of the plurality of measurement parameters relative to the alternative measurement parameters. For example, the global sensitivity indices can be determined to calculate the effects of a first measurement parameter with a second measurement parameter, a third measurement parameter, a fourth measurement parameter, a fifth measurement parameter, a sixth measurement parameter, a seventh measurement parameter, an eighth measurement parameter, a ninth measurement parameter, a tenth measurement parameter, and/or a combination thereof. As a further example, the global sensitivity indices can be determined to calculate the effects of a first measurement parameter with an exogenous parameter, e.g., noise.

In some embodiments, the global sensitivity indices can be determined to quantitatively compare the sensitivity of each measurement channel of the plurality of measurement channels, in which each measurement channel includes a plurality of measurement parameters. In some embodiments, the global sensitivity indices can determine whether the plurality of measurement parameters will be sensitive in the presence of noise. Without being bound by theory, by determining the global sensitivity indices for each measurement channel using the plurality of measurement parameters, the measurement channels may be numerically categorized and/or ranked to determine which measurement channel can provide the most sensitive and/or accurate inversion data.

In some embodiments, determining the global sensitivity indices can include determining a local sensitivity indices. The local sensitivity indices can calculate the sensitivity of the measurement parameter based on the local parameter variations, e.g., variations in each measurement parameter of the plurality of measurement parameters relative to the same measurement parameter. In some embodiments, the local sensitivity indices can be determined by identifying the measurement parameter range for each measurement parameter. The measurement parameter range can include any of the measurement parameter range as described herein. The computing system 32 can receive the noise model and determine the local sensitivity indices for each measurement parameter of the plurality of measurement parameter using the measurement parameter, the measurement parameter range, and the noise model.

At operation 312, the computing system 32 ranks each measurement channel of the plurality of measurement channels. In some embodiments, ranking can include ranking based on the global sensitivity indices, the sensitivity of the resistivities in a one dimensional formation, the sensitivity of the resistivities in a two dimensional formation, the sensitivity of the resistivities based on one or more measurement parameters, e.g., distance to a boundary of the wellbore, and/or the sensitivity of the resistivities of a two dimensional transverse formation.

The computing system 32 can rank each measurement channel by assigning an alpha-numeric value to each measurement channel corresponding to the global sensitivity indices. In some embodiments, the alpha-numeric value can include numbers and/or letters to indicate a ranking. In some embodiments, the alpha-numeric value can indicate higher numbers and/or letters to have greater sensitivity than lower numbers and/or letters. In some embodiments, the alpha-numeric value can indicate lower numbers and/or letters to have greater sensitivity than higher numbers and/or letters. For example, a first measurement channel can include a global sensitivity indices ranking of 1, while a second measurement channel can include a global sensitivity indices ranking of 100, in which the first measurement channel would be indicated as having a higher sensitivity in the wellbore than the second measurement channel. Alternatively, and for example, a first measurement channel can include a global sensitivity indices ranking of 1, while a second measurement channel can include a global sensitivity indices ranking of 100, in which the second measurement channel would be indicated as having a higher sensitivity in the wellbore than the second measurement channel.

In some embodiments, the computing system 32 can rank each measurement channel of the plurality of measurement channels in a time period of about 0.001 ms to about 60 s, e.g., about 0.001 ms to about 30 s, about 0.01 ms to about 10 s, or about 0.1 ms to about 1 s. Without being bound by theory, by ranking each measurement channel of the plurality of measurement channels in a time period of 0.001 ms to about 60 s, a rapid determination of the sensitivity of the measurement channel can be ranked, thereby allowing for rapid and/or real-time determinations pre-drilling, post-drilling, and/or during drilling of the wellbore.

In some embodiments, operation 312 can include receiving a selection threshold. The selection threshold can include one or more thresholds indicating the number of measurement channels that can be transmitted via telemetry to the computing system 32 without hindering bandwidth and/or reducing transmission speed. In some embodiments, the selection threshold can include a weight percent threshold. The weight percent threshold can include a numerical value, e.g., a defined percentage, for each group of sensitivity indices. In some embodiments, the weight percent threshold can be pre-defined and/or obtained from user input. In some embodiments, the weight percent threshold can be used to calculate a weight-averaged sensitivity indices to the combined ranking of the measurement channels to be transmitted via telemetry to the computing system 32. In some embodiments, the selection threshold can include a numerical threshold. The numerical threshold is a numerical value, e.g., a defined number, for each group of sensitivity indices. The numerical can be pre-defined or directly obtained from user input. In some embodiments, the numerical threshold can be used to calculate the overall sensitivity indices for measurement channels to be transmitted via telemetry to the computing system 32. For example, a user can enter the selection threshold into the computing system 32 via a display device and/or other form of entering inputs into the computing system 32.

In some embodiments, operation 312 can include selecting at least a portion of the plurality of measurement channels based on the selection threshold. In some embodiments, selecting the at least a portion of the plurality of measurement channels can include selecting about 50 measurement channels to about 200 measurement channels, e.g., about 50 measurement channels to about 150 measurement channels, about 80 measurement channels to about 120 measurement channels, or about 90 measurement channels to about 110 measurement channels, to be transmitted via telemetry to the computing system 32.

In some embodiments, the selection of the at least a portion of measurement channels can be performed before drilling the wellbore, during drilling of the wellbore, and/or after drilling of the wellbore. In some embodiments, the measurement tool is in the wellbore during the drilling of the wellbore, before drilling of the wellbore, and/or after drilling of the wellbore. In some embodiments, the selection of the at least a portion of measurement channels can be based on a channel availability. In some embodiments, a measurement channel may be unavailable due to borehole assembly constraints or variances. For example, a first measurement channel may be unavailable due to a frequency of the first measurement channel interfering with a second measurement channel, in which both the first measurement channel and the second measurement channel may become unavailable. In some embodiments, the selection of the at least a portion of measurement channels can be based on a measurement quality. In some embodiments, a measurement quality can include one or more of a tool health quality, a downhole vibration resonant frequency, or a combination thereof. Without being bound by theory, by selecting the at least a portion of the plurality of measurement channels, the transmission of the inversion data, via telemetry, may occur at increased speeds compared to conventional logging techniques. Moreover, and without being bound by theory, by selecting the at least a portion of the plurality of measurement channels, the measurement channels having higher sensitivity may be selected and transmitted compared to measurement channels having lower sensitivity, thereby maintaining quality of the inversion data transmitted via telemetry.

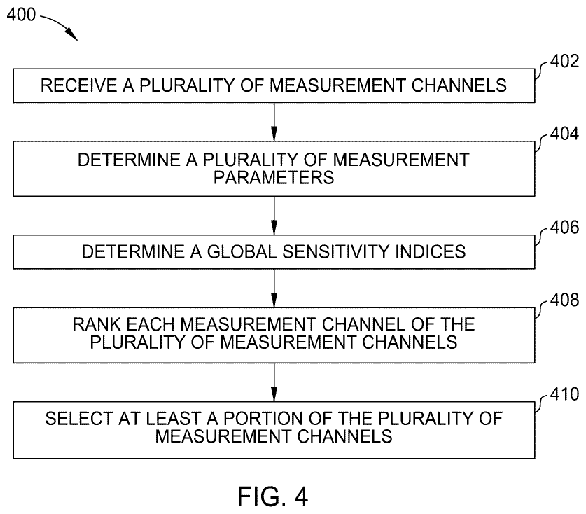

Now referring to FIG. 4, a method 400 of selecting a plurality of measurement channels is shown. At operation 402, a computing system 32 receives a plurality of measurement channels from a logging tool. In some embodiments, the plurality of measurement channels can include about 100 measurement channels to about 2,000 measurement channels, e.g., about 500 measurement channels to about 1,800 measurement channels, about 1,000 measurement channels to about 1,500 measurement channels, or about 1,200 measurement channels to about 1,400 measurement channels. In some embodiments, the measurement channels can include a combination of shallow, medium, and deep measurement spacing channels. In some embodiments, the plurality of measurement channels is based on the logging tool. For example, a MWD logging technique incorporating tilted and/or transverse antennas capable of providing deep directional resistivities, e.g., PERISCOPE™ and/or GEOSPHERE™ provided by Schlumberger of Houston, TX, can provide about 100 measurement channels to about 100,000 measurement channels.

At operation 404, the computing system 32 determines a plurality of measurement parameters for each measurement channel of the plurality of measurement channels. The plurality of measurement parameters can include one or more of the horizontal resistivity, Rₕ₁, of the first layer 202, the horizontal resistivity, Rₕ₂, of the second layer 204, the horizontal resistivity, Rₕ₃, of the third layer 206, the anisotropy ratio of the first layer 202, e.g., Rᵥ₁/Rₕ₁, the anisotropy ratio of the second layer 204, e.g., Rᵥ₂/Rₕ₂, the fault angle, θ, the vertical offset, d, the wellbore to first layer 202 distance, h₁, and/or the wellbore to third layer 206 distance, h₂. In some embodiments, the computing system 32 can determine each of the horizontal resistivity, Rₕ₁, of the first layer 202, the horizontal resistivity, Rₕ₂, of the second layer 204, the horizontal resistivity, Rₕ₃, of the third layer 206, the anisotropy ratio of the first layer 202, e.g., Rᵥ₁/Rₕ₁, the anisotropy ratio of the second layer 204, e.g., Rᵥ₂/Rₕ₂, the fault angle, θ, the vertical offset, d, the wellbore to first layer 202 distance, h₁, and/or the wellbore to third layer 206 distance, h₂, for each measurement channel of the plurality of measurement channels. For example, the computing system 32 can determine an Rₕ₁ of about 1.0 ohm·m, an Rₕ₂ of about 58.58 ohm·m, an Rₕ₃ of about 0.65 ohm·m, an Rᵥ₁/Rₕ₁ of about 3.13, an Rₕ₂/Rₕ₂ of about 2.95, a θ of about 103.7, a d of about −7.87 m, an h₁ of about 6.63 m, and an h₂ of about 7.30 m.

At operation 406, a global sensitivity indices is determined using the measurement parameters and a sampling distribution. The global sensitivity indices can calculate the sensitivity of the measurement parameter based on both the local parameter variations, e.g., variations in each measurement parameter of the plurality of measurement parameters relative to the same measurement parameter, and/or global parameter changes, e.g., variations in each measurement parameter of the plurality of measurement parameters relative to the alternative measurement parameters. For example, the global sensitivity indices can be determined to calculate the effects of a first measurement parameter with a second measurement parameter, a third measurement parameter, a fourth measurement parameter, a fifth measurement parameter, a sixth measurement parameter, a seventh measurement parameter, an eighth measurement parameter, a ninth measurement parameter, a tenth measurement parameter, and/or a combination thereof. As a further example, the global sensitivity indices can be determined to calculate the effects of a first measurement parameter with an exogenous parameter, e.g., noise.

In some embodiments, the global sensitivity indices can be determined to quantitatively compare the sensitivity of each measurement channel of the plurality of measurement channels, in which each measurement channel includes a plurality of measurement parameters. In some embodiments, the global sensitivity indices can determine whether the plurality of measurement parameters will be sensitive in the presence of noise. Without being bound by theory, by determining the global sensitivity indices for each measurement channel using the plurality of measurement parameters, the measurement channels may be numerically categorized and/or ranked to determine which measurement channel can provide the most sensitive and/or accurate inversion data.

In some embodiments, determining the global sensitivity indices can include determining a local sensitivity indices. The local sensitivity indices can calculate the sensitivity of the measurement parameter based on the local parameter variations, e.g., variations in each measurement parameter of the plurality of measurement parameters relative to the same measurement parameter. In some embodiments, the local sensitivity indices can be determined by identifying the measurement parameter range for each measurement parameter. The measurement parameter range can include any of the measurement parameter range as described herein. The computing system 32 can receive a noise model and determine the local sensitivity indices for each measurement parameter of the plurality of measurement parameter using the measurement parameter, the measurement parameter range, and the noise model.

The noise model can indicate one or more realistic noise and/or systematic errors corresponding to the logging tool. For example, the realistic noise can include electronic noise, fluctuation-induced noise, receiver tool face angle measurement noise, transmitter-receiver alignment angle noise, and a combination thereof. As a further example, the systematic errors can include gain mismatch, title angle, alignment angle and bending, and a combination thereof. In some embodiments, the realistic noise and systematic errors can be received based on the acquired well log data, lab measurements, and/or one or more simulations which can apply an error distribution model. The error distribution model may apply a random generation of errors to determine the error distribution. The error distribution model can be defined by various mathematical functions and algorithms, such as Gaussian error assumption, homogenous error assumption, Laplacian error assumption, or combinations thereof.

The sampling distribution of the plurality of measurement parameters is identified using the measurement parameter range for each measurement parameter. For example, the sampling distribution can be identified based on one or more samples in the parameter space, e.g., measurement parameter range. In some embodiments, the sampling distribution can be identified using the Saltelli sampling method to generate samples in the parameter space. For example, the sampling distribution can be identified using the Saltelli sampling method such that about 10,000 sample points to about 30,000 sample points, e.g., about 10,000 sampling points to about 25,000 sampling points, about 15,000 sampling points to about 23,000 sampling points, or about 20,000 sampling points to about 21,000 sampling points, can be identified within the measurement parameter range. Without being bound by theory, the sampling distribution can provide enhanced sensitivity analysis due to the close and/or overlapping sampling points, thereby allowing local sensitivity of each measurement parameter to be determined. Moreover, the sampling distribution can identify local parameter variations, e.g., variations in each measurement parameter of the plurality of measurement parameters relative to the same measurement parameter, and/or global parameter changes, e.g., variations in each measurement parameter of the plurality of measurement parameters relative to the alternative measurement parameters.

At operation 408, the computing system 32 ranks each measurement channel of the plurality of measurement channels. In some embodiments, ranking can include ranking based on the global sensitivity indices, the sensitivity of the resistivities in a one dimensional formation, the sensitivity of the resistivities in a two dimensional formation, the sensitivity of the resistivities based on one or more measurement parameters, e.g., distance to a boundary of the wellbore, and/or the sensitivity of the resistivities of a two dimensional transverse formation.

The computing system 32 can rank each measurement channel by assigning an alpha-numeric value to each measurement channel corresponding to the global sensitivity indices. In some embodiments, the alpha-numeric value can include numbers and/or letters to indicate a ranking. In some embodiments, the alpha-numeric value can indicate higher numbers and/or letters to have greater sensitivity than lower numbers and/or letters. In some embodiments, the alpha-numeric value can indicate lower numbers and/or letters to have greater sensitivity than higher numbers and/or letters. For example, a first measurement channel can include a global sensitivity indices ranking of 1, while a second measurement channel can include a global sensitivity indices ranking of 100, in which the first measurement channel would be indicated as having a higher sensitivity in the wellbore than the second measurement channel. Alternatively, and for example, a first measurement channel can include a global sensitivity indices ranking of 1, while a second measurement channel can include a global sensitivity indices ranking of 100, in which the second measurement channel would be indicated as having a higher sensitivity in the wellbore than the second measurement channel.

In some embodiments, the computing system 32 can rank each measurement channel of the plurality of measurement channels in a time period of about 0.001 ms to about 60 s, e.g., about 0.001 ms to about 30 s, about 0.01 ms to about 10 s, or about 0.1 ms to about 1 s. Without being bound by theory, by ranking each measurement channel of the plurality of measurement channels in a time period of 0.001 ms to about 60 s, a rapid determination of the sensitivity of the measurement channel can be ranked, thereby allowing for rapid and/or real-time determinations pre-drilling, post-drilling, and/or during drilling of the wellbore.

At operation 410, the computing system 32 selects at least a portion of the plurality of measurement channels by receiving a selection threshold. The selection threshold can include one or more thresholds indicating the number of measurement channels that can be transmitted via telemetry to the computing system 32 without hindering bandwidth and/or reducing transmission speed. In some embodiments, the selection threshold can include a weight percent threshold. The weight percent threshold can include a numerical value, e.g., a defined percentage, for each group of sensitivity indices. In some embodiments, the weight percent threshold can be pre-defined and/or obtained from user input. In some embodiments, the weight percent threshold can be used to calculate a weight-averaged sensitivity indices to the combined ranking of the measurement channels to be transmitted via telemetry to the computing system 32. In some embodiments, the selection threshold can include a numerical threshold. The numerical threshold is a numerical value, e.g., a defined number, for each group of sensitivity indices. The numerical can be pre-defined or directly obtained from user input. In some embodiments, the numerical threshold can be used to calculate the overall sensitivity indices for measurement channels to be transmitted via telemetry to the computing system 32. For example, a user can enter the selection threshold into the computing system 32 via a display device and/or other form of entering inputs into the computing system 32.

At operation 410, the computing system 32 selects at least a portion of the plurality of measurement channels by selecting the at least a portion of the plurality of measurement channels based on the selection threshold. In some embodiments, selecting the at least a portion of the plurality of measurement channels can include selecting about 50 measurement channels to about 200 measurement channels, e.g., about 50 measurement channels to about 150 measurement channels, about 80 measurement channels to about 120 measurement channels, or about 90 measurement channels to about 110 measurement channels, to be transmitted via telemetry to the computing system 32. In some embodiments, the selection of the at least a portion of measurement channels can be performed before drilling the wellbore, during drilling of the wellbore, and/or after drilling of the wellbore. Without being bound by theory, by selecting the at least a portion of the plurality of measurement channels, the transmission of the inversion data, via telemetry, may occur at increased speeds compared to conventional logging techniques. Moreover, and without being bound by theory, by selecting the at least a portion of the plurality of measurement channels, the measurement channels having higher sensitivity may be selected and transmitted compared to measurement channels having lower sensitivity, thereby maintaining quality of the inversion data transmitted via telemetry.

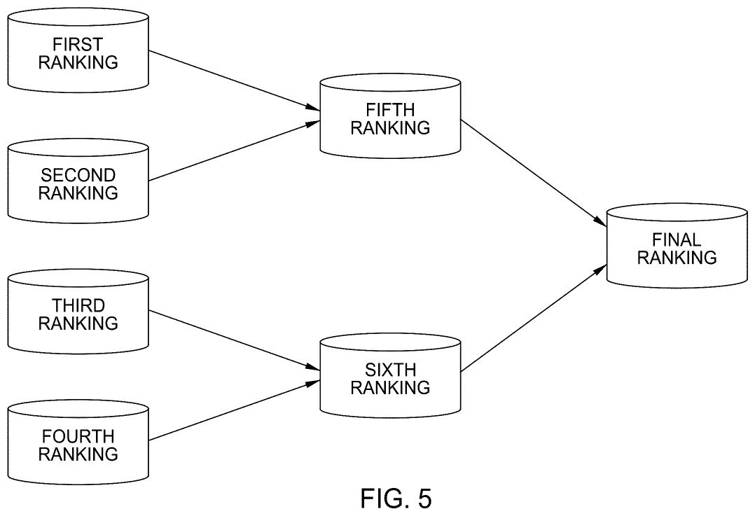

Now referring to FIG. 5 a first measurement channel selection process is shown. In some embodiments, a first measurement channel selection process can include a first ranking of the plurality of measurement channels according to a local sensitivity indices including a one-dimensional longitudinal measurement parameter. In some embodiments, a first measurement channel selection process can include a second ranking of the plurality of measurement channels according to a local sensitivity indices including a two-dimensional longitudinal measurement parameter. In some embodiments, a first measurement channel selection process can include a third ranking of the plurality of measurement channels according to a local sensitivity indices including a one-dimensional transverse measurement parameter. In some embodiments, a first measurement channel selection process can include a fourth ranking of the plurality of measurement channels according to a local sensitivity indices including a two-dimensional transverse measurement parameter.

In some embodiments, the first ranking and the second ranking may be further ranked to produce a fifth ranking, e.g., an overall sensitivity in the longitudinal direction. In some embodiments, the fifth ranking may be produced according to a weight percent of the first ranking and the second ranking. For example, the fifth ranking may be produced by incorporating 30 wt % of the first ranking and 70 wt % of the second ranking. In some embodiments, the third ranking and the fourth ranking may be further ranked to produce a sixth ranking, e.g., an overall sensitivity in the transverse direction. In some embodiments, the sixth ranking may be produced according to a weight percent of the third ranking and the fourth ranking. For example, the sixth ranking may be produced by incorporating 50 wt % of the third ranking and 50 wt % of the fourth ranking.

In some embodiments, a final ranking may be produced based on the fifth ranking, and the sixth ranking. In some embodiments, the final ranking may include a weight percent of the fifth ranking and the sixth ranking For example, the final ranking may be produced by incorporating 80 wt % of the fifth ranking and 20 wt % of the sixth ranking.

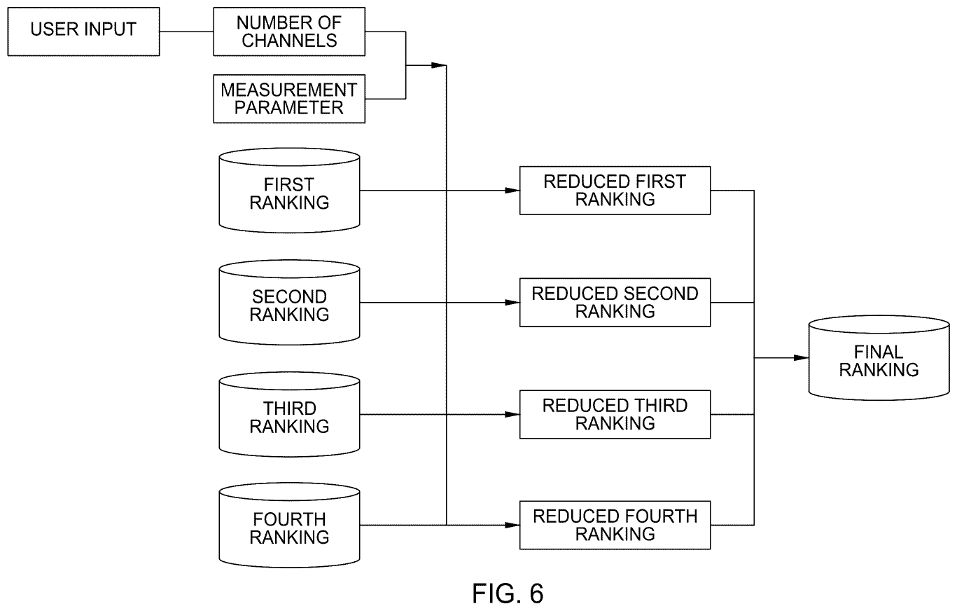

Now referring to FIG. 6 a second measurement channel selection process is shown. The second measurement process can include receiving a user input indicating the number of channels to be selected from the global sensitivity indices. Additionally, the user input can indicate a measurement parameter preference, e.g., a one dimensional longitudinal measurement parameter, a two dimensional longitudinal measurement parameter, a one dimensional transverse parameter, and/or a two dimensional transverse parameter. The second measurement channel selection process can include a first ranking of the plurality of measurement channels according to a local sensitivity indices including a one-dimensional longitudinal measurement parameter. The second measurement channel selection process can include a second ranking of the plurality of measurement channels according to a local sensitivity indices including a two-dimensional longitudinal measurement parameter. The second measurement channel selection process can include a third ranking of the plurality of measurement channels according to a local sensitivity indices including a one-dimensional transverse measurement parameter. The second measurement channel selection process can include a fourth ranking of the plurality of measurement channels according to a local sensitivity indices including a two-dimensional transverse measurement parameter.

In some embodiments, a reduced first ranking, reduced second ranking, reduced third ranking, and reduced fourth ranking may be produced based on the user input. In some embodiments, a final ranking may be produced based on the reduced first ranking, reduced second ranking, reduced third ranking, and reduced fourth ranking. In some embodiments, the final ranking may include a number of channels from each of the reduced first ranking, reduced second ranking, reduced third ranking, and reduced fourth ranking.

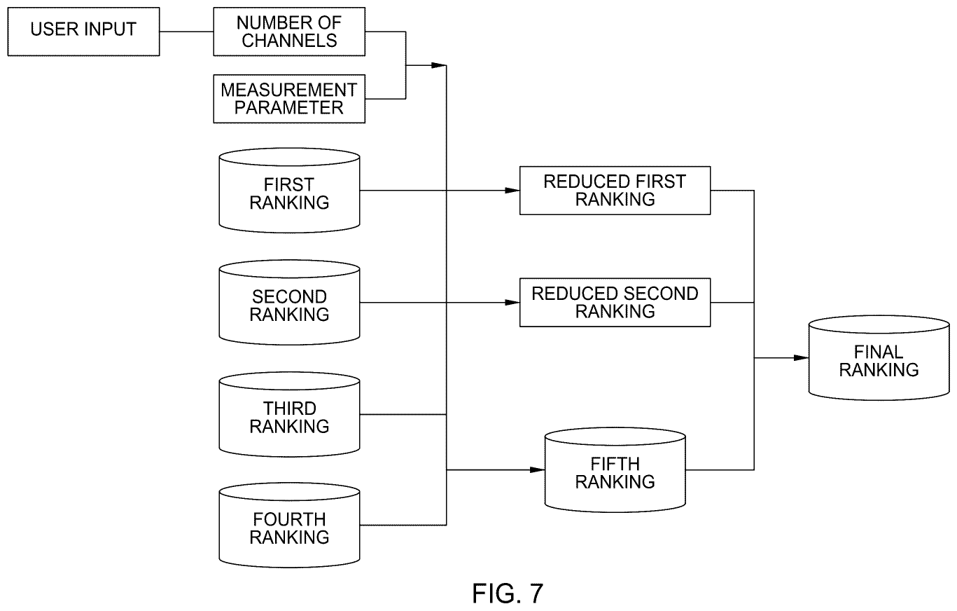

Now referring to FIG. 7 a third measurement channel selection process is shown. The third measurement process can include receiving a user input indicating the number of channels to be selected from the global sensitivity indices. Additionally, the user input can indicate a measurement parameter preference, e.g., a one dimensional longitudinal measurement parameter, a two dimensional longitudinal measurement parameter, a one dimensional transverse parameter, and/or a two dimensional transverse parameter. The third measurement channel selection process can include a first ranking of the plurality of measurement channels according to a local sensitivity indices including a one-dimensional longitudinal measurement parameter. The third measurement channel selection process can include a second ranking of the plurality of measurement channels according to a local sensitivity indices including a two-dimensional longitudinal measurement parameter. The third measurement channel selection process can include a third ranking of the plurality of measurement channels according to a local sensitivity indices including a one-dimensional transverse measurement parameter. The third measurement channel selection process can include a fourth ranking of the plurality of measurement channels according to a local sensitivity indices including a two-dimensional transverse measurement parameter.

In some embodiments, a reduced first ranking and a reduced second ranking may be produced based on the user input. In some embodiments, the third ranking and the fourth ranking may be further ranked to produce a fifth ranking using the user input. e.g., an overall sensitivity in the transverse direction. In some embodiments, the sixth ranking may be produced according to the user input indicating a weight percent of the third ranking and the fourth ranking. For example, the fifth ranking may be produced by incorporating 20 wt % of the third ranking and 80 wt % of the fourth ranking. In some embodiments, a final ranking may be produced based on the reduced first ranking, reduced second ranking, and the fifth ranking. In some embodiments, the final ranking may include a number of channels from each of the reduced first ranking, reduced second ranking, and fifth ranking.

### Examples

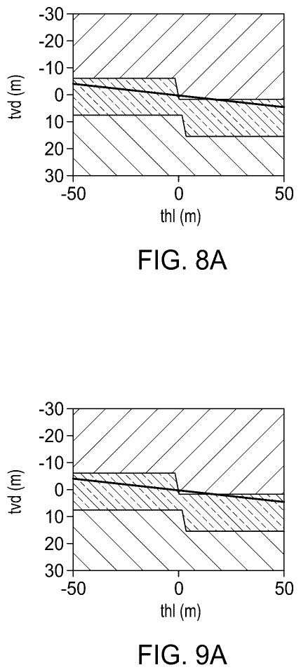

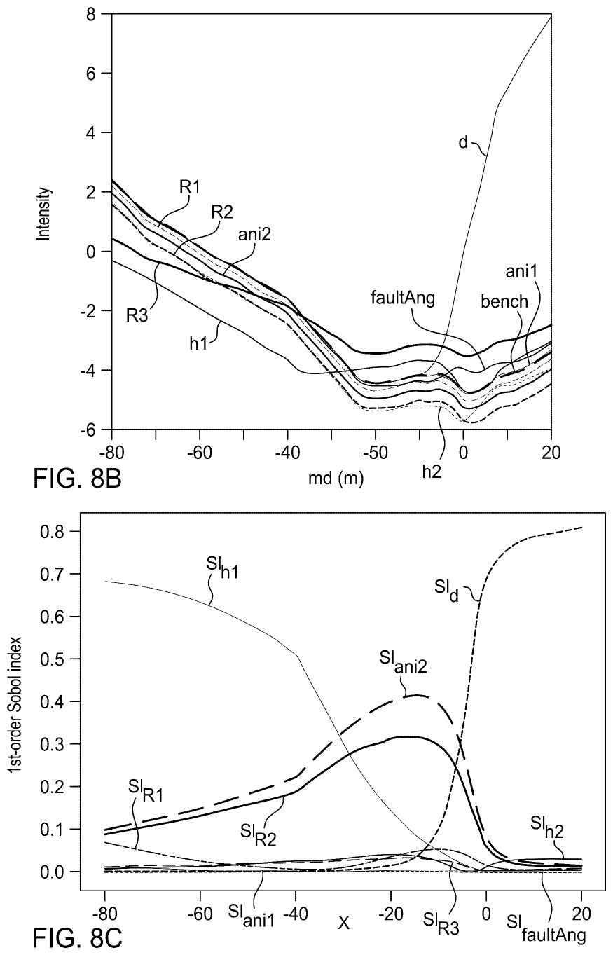

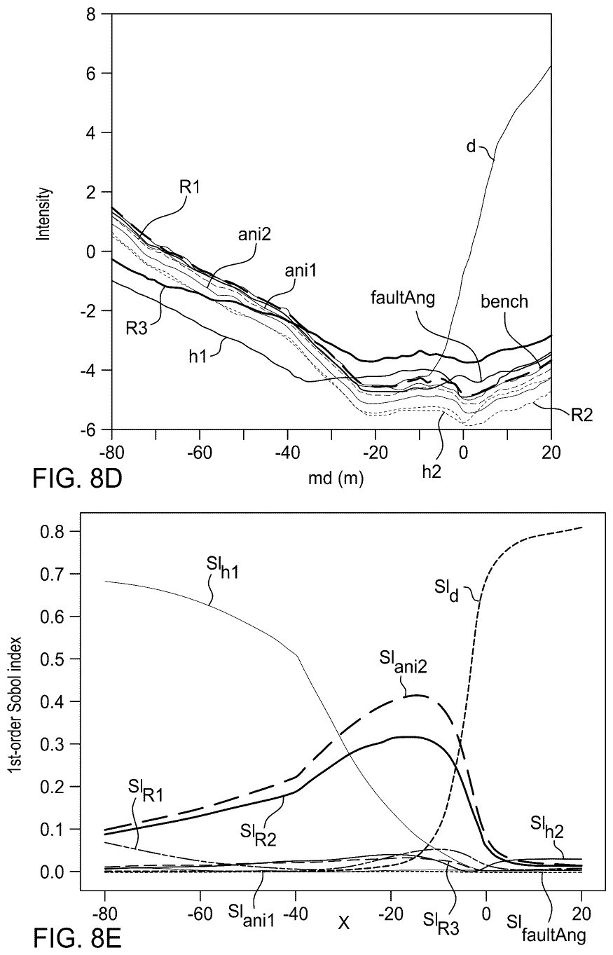

Now referring to FIGS. 8A-8E local sensitivity indices and global sensitivity indices of a first measurement channel in a three-layer formation, as shown in FIG. 8A, are shown. The first measurement channel was monitored during the presence of noise and without the presence of noise in which the first measurement channel without noise was used as the benchmark reference “bench” for the noise collection samples, as shown in FIGS. 8B and 8C, and the first measurement channel with noise was used as the benchmark reference “bench” for the noise collection samples, as shown in FIGS. 8D and 8E. The local sensitivity indices for each of Rₕ₁, Rₕ₂, Rₕ₃, Rᵥ₁/Rₕ₁, Rᵥ₂/Rₕ₂, θ, d, h₁, and h₂ were monitored, as shown in FIGS. 8B (without noise) and 8D (with noise). The global sensitivity indices for each of Rₕ₁, Rₕ₂, Rₕ₃, Rᵥ₁/Rₕ₁, Rᵥ₂/Rₕ₂, θ, d, h₁, and h₂ were monitored, as shown in FIGS. 8C (without noise) and 8E (with noise). Without being bound by theory, the first measurement channel displayed sensitivity in the wellbore even with the presence of noise.

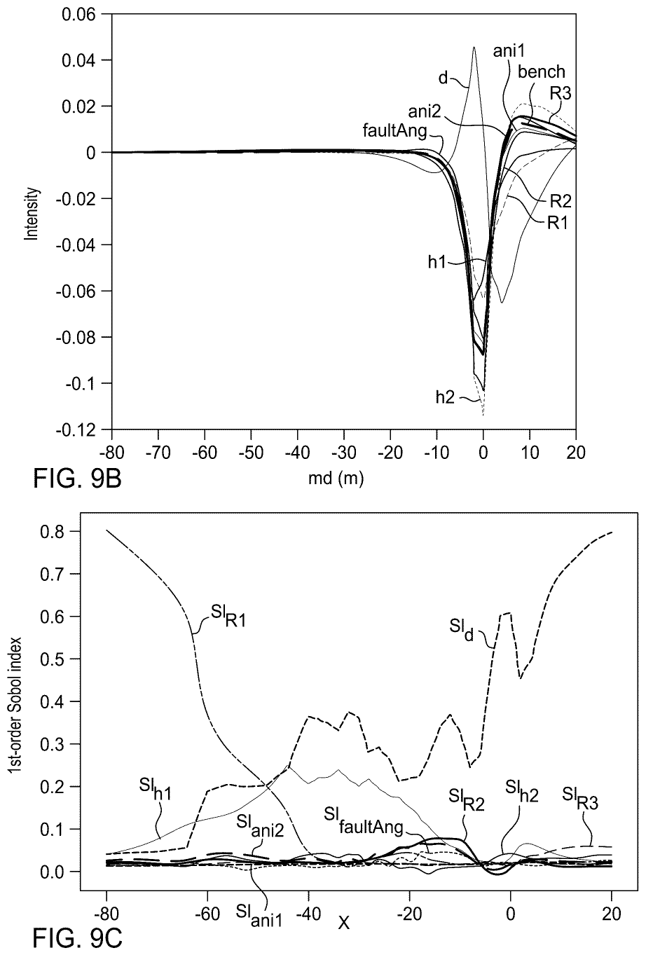

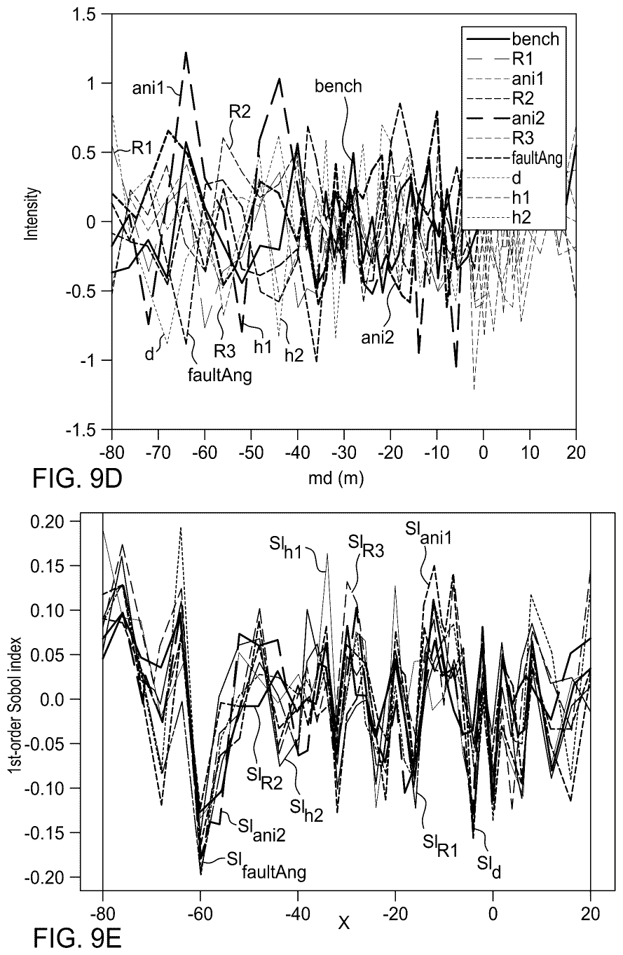

Now referring to FIGS. 9A-9E local sensitivity indices and global sensitivity indices of a second measurement channel in a three-layer formation, as shown in FIG. 9A, are shown. The second measurement channel was monitored during the presence of noise and without the presence of noise in which the second measurement channel without noise was used as the benchmark reference “bench” for the noise collection samples, as shown in FIGS. 9B and 9C, and the second measurement channel with noise was used as the benchmark reference “bench” for the noise collection samples, as shown in FIGS. 9D and 9E. The local sensitivity indices for each of Rₕ₁, Rₕ₂, Rₕ₃, Rᵥ₁/Rₕ₁, Rᵥ₂/Rₕ₂, θ, d, h₁, and h₂ were monitored, as shown in FIGS. 9B (without noise) and 9D (with noise). The global sensitivity indices for each of Rₕ₁, Rₕ₂, Rₕ₃, Rᵥ₁/Rₕ₁, Rᵥ₂/Rₕ₂, θ, d, h₁, and h₂ were monitored, as shown in FIGS. 9C (without noise) and 9E (with noise). Without being bound by theory, the second measurement channel was sensitive to noise, in which the inversion data was determined to not be sensitive to the measurement parameters of the formation and/or wellbore.

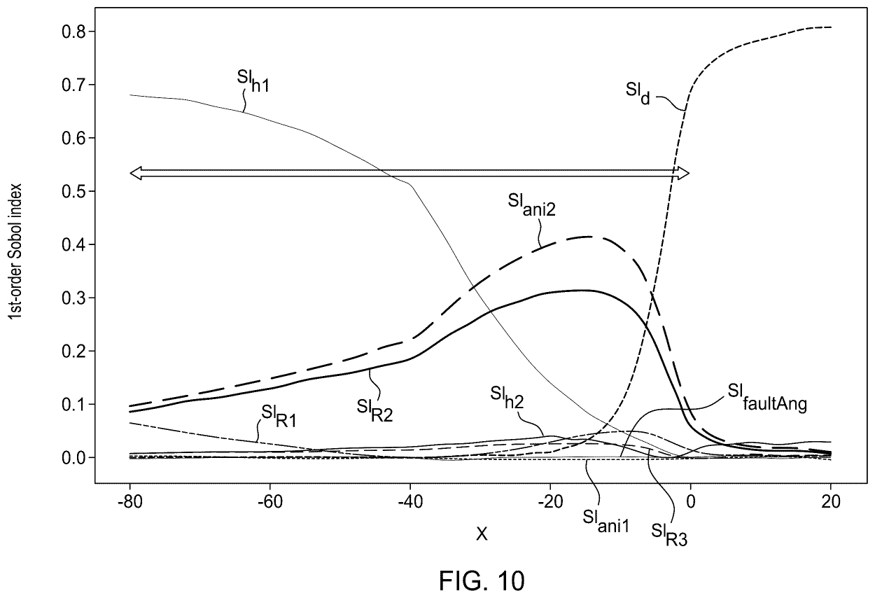

A global sensitivity indices of 1040 measurement channels for shallow, medium and deep responses having both sensitive measurement channels, e.g., first measurement channel, and non-sensitive measurement channels, e.g., second measurement channel were analyzed. It was determined that 456 measurement channels were non-sensitive, and/or produced noisy global sensitive indices, and thus were removed. Of the remaining 584 measurement channels, the global sensitivity indices for each measurement channel of the 584 measurement channels was averaged over the depth interval from −80 m to Om, e.g., the location of the fault, as shown in FIG. 10. The global sensitivity indices was calculated based on the sum of the local sensitivity indices for each of the measurement parameters within the 584 measurement channels.

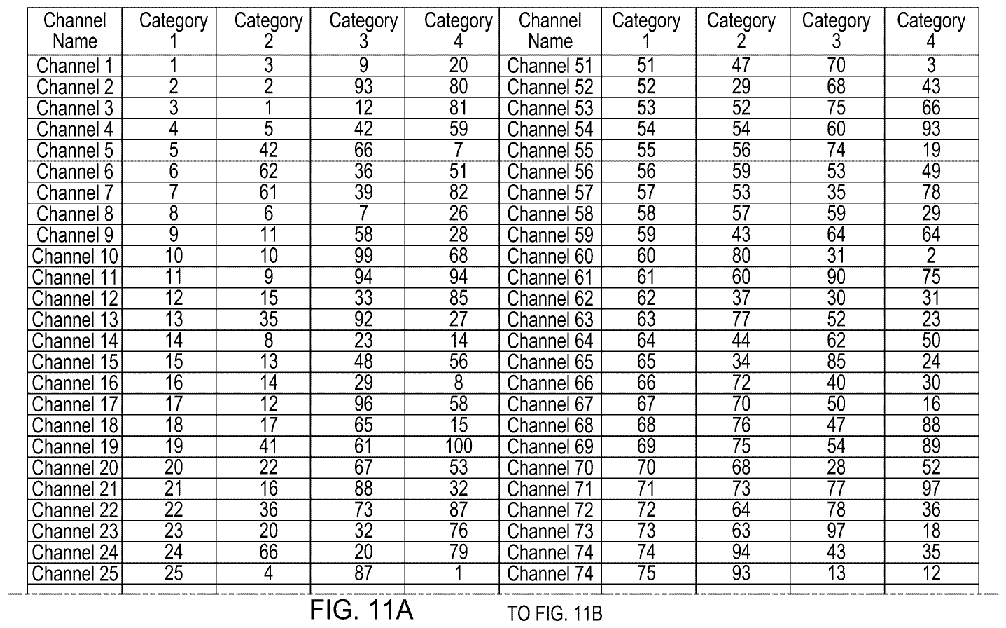

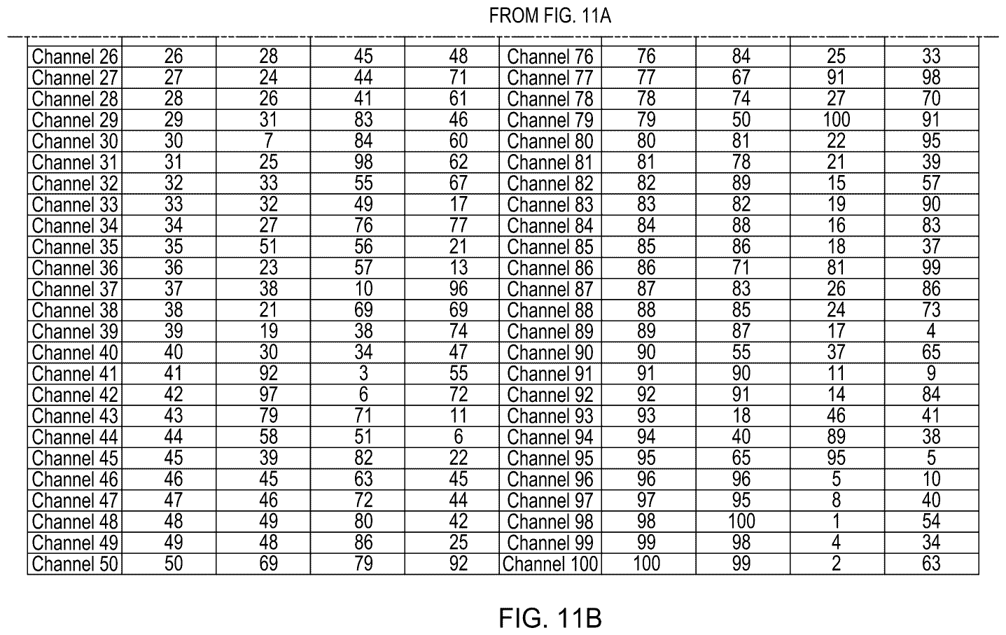

As shown in FIGS. 11A and 11B, an exemplary table of 100 ranked measurement channels is shown. Channel name lists the measurement channel number, category 1 gives the ranking of the global sensitivity indices (SI) for the combination of all 9 parameters, category 2 is the global sensitivity indices ranking of 7 parameters, e.g., without the parameter fault angle measurement parameter and the fault displacement measurement parameter. In some embodiments, category 2 corresponds to the sensitivity of the measurement channel in a 1D formation. Categories 3 and 4 represent global sensitivity indices (SI) ranking for the combination of all 9 parameters, representing the look-ahead sensitivity and the look-around sensitivity of the 2D or 3D formation, respectively.

In some embodiments, where the telemetry bandwidth limit is limited to 100 measurement channels, the computing system 32 can select the at least a portion of the plurality of measurement channels using each of the categories 1, 2, 3, and/or 4. For example, in a 1D formation for deep reading, the top 50 measurement channels from category 2 may be selected, in which the remaining 50 measurement channels may be from category 1, excluding the measurement channels already in category 2. As a further example, in a complex 2D/3D formation, the top 40 measurement channels from category 1 may be selected, in which 30 measurement channels from category 3 may be selected, excluding the measurement channels already in category 1, and the remaining 30 measurement channels from category 4 may be selected, excluding the measurement channels already in category 1 and category 3. As a further example, in a 2D transverse formation, the top 50 wt % of the measurement channels from category 1 may be selected, in which the remaining 50 wt % may be selected from category 4, excluding the measurement channels from category 1.

As a further example, the computing system 32 can select the at least a portion of the plurality of measurement channels based on shallow, medium, and deep spacings. For example, the section can include 20% shallow channels from category 2, 20% medium channels from category 2, 30% deep channels from category 3, and 30% deep channels from category 4. In some embodiments, the second order sensitivity indices can be utilized to estimate the influence of groups of variables on model output. For example, the convoluted effects from both resistivities and the distance to the bed boundary.

Overall, the present disclosure can increase the rate of telemetry using local sensitivity indices and/or global sensitivity indices to restrict the total number of measurement channels that are sent and/or processed, thereby increasing the speed of signal transfer from the measurement tool to the computing system. Moreover, the measurement channels that are transmitted to the computing system may be ranked and/or selected using the local sensitivity indices and/or global sensitivity indices to provide increased sensitivity and/or resolution, thereby increasing the quality of the mapping of the formation. Additionally, the present disclosure allows for the ranking and/or selection of measurement channels during drilling, thereby allowing for real-time and/or rapid channel selection when encountering formations in a wellbore, thereby increasing efficiency of wellbore drilling.

The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the present disclosure, additionally, they do not exclude impurities and variances normally associated with the elements and materials used.

Numerical ranges used herein include the numbers recited in the range. For example, the numerical range “from 1 wt % to 10 wt %” includes 1 wt % and 10 wt % within the recited range.

For the sake of brevity, only some ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

All numerical values within the detailed description herein are modified by “about” the indicated value, and take into account experimental error and variations that would be expected by a person having ordinary skill in the art.

All documents described herein are incorporated by reference herein, including any priority documents and or testing procedures to the extent they are not inconsistent with this text. As is apparent from the foregoing general description and the specific embodiments, while forms of the present disclosure have been illustrated and described, various modifications can be made without departing from the spirit and scope of the present disclosure. Accordingly, it is not intended that the present disclosure be limited thereby. Likewise, the term “comprising” is considered synonymous with the term “including” for purposes of United States law. Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

The specific embodiments described herein have been illustrated by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform)ing (a function) . . . ”, it is intended that such elements are to be interpreted under 35 U.S.C. 112(f). However, for any claims containing elements designated in any other manner, it is intended that such elements are not to be interpreted under 35 U.S.C. 112(f).

### Embodiments

Implementation examples are described in the following numbered clauses:

E1. A method of ranking a plurality of measurement channels, comprising receiving a plurality of measurement channels for a logging tool; determining a plurality of measurement parameters for each measurement channel of the plurality of measurement channels of a formation of a wellbore; determine a global sensitivity indices, wherein determining the global sensitivity indices comprises: identifying a sampling distribution of the plurality of measurement parameters using a measurement parameter range for each measurement parameter; receiving a noise model; and determining the global sensitivity indices using the measurement parameters, the sampling distribution, and the noise model; and ranking each measurement channel of the plurality of measurement channels using the global sensitivity indices.

E2. The method of embodiment E1, further comprising receiving a selection threshold; and selecting at least a portion of the plurality of measurement channels based on the selection threshold.

E3. The method of embodiments E1 or E2, wherein receiving the selection threshold comprises receiving a user input.

E4. The method of embodiments E2 or E3, wherein the selection threshold comprises a weight percent threshold.

E5. The method of embodiments E2 or E3, wherein the selection threshold comprises a numerical threshold.

E6. The method of any one of embodiments E2-E5, wherein selecting at least a portion of the plurality of measurement channels based on the selection threshold is performed before drilling the wellbore, during drilling of the wellbore, or after drilling the wellbore.

E7. The method of any one of embodiments E1-E6, wherein determining the global sensitivity indices further comprises determining a local sensitivity indices for each measurement parameter of the plurality of measurement parameters.

E8. The method of embodiment E7, wherein determining the local sensitivity indices comprises identifying each measurement parameter range for each measurement parameter; receiving the noise model; and determining the local sensitivity for each measurement parameter of the plurality of measurement parameters using the measurement parameter, the measurement parameter range, and the noise model.

E9. A method of selecting measurement channels, comprising receiving a plurality of measurement channels for a logging tool; determining a plurality of measurement parameters for each measurement channel of the plurality of measurement channels of a formation of a wellbore; determine a global sensitivity indices using the plurality of measurement parameters and a sampling distribution; ranking each measurement channel of the plurality of measurement channels using the global sensitivity indices; and selecting at least a portion of the plurality of measurement channels, wherein selecting the at least a portion of the plurality of measurement channels comprises receiving a selection threshold; and selecting the at least a portion of the plurality of measurement channels based on the selection threshold.

E10. The method of embodiment E9, wherein receiving the selection threshold comprises receiving a user input.

E11. The method of embodiment E9 or E10, wherein the selection threshold comprises a weight percent threshold.

E12. The method of embodiment E9 or E10, wherein the selection threshold comprises a numerical threshold.

E13. The method of any one of embodiments E9-E12, wherein determining the global sensitivity indices further comprises determining a local sensitivity indices for each measurement parameter of the plurality of measurement parameters.

E14. The method of claim 13, wherein determining the local sensitivity indices comprises identifying each measurement parameter range for each measurement parameter; receiving a noise model; and determining the local sensitivity for each measurement parameter of the plurality of measurement parameters using the measurement parameter, the measurement parameter range, and the noise model.

E15. The method of any one of embodiments E9-E14, wherein selecting at least a portion of the plurality of measurement channels based on the selection threshold is performed before drilling the wellbore, during drilling of the wellbore, or after drilling the wellbore.

E16. A system comprising one or more processors; memory operatively coupled to the one or more processors; and processor-executable instructions stored in the memory and executable by at least one of the processors to instruct the system to receive a plurality of measurement channels for a logging tool; determine a plurality of measurement parameters for each measurement channel of the plurality of measurement channels of a formation of a wellbore; determine a global sensitivity indices, wherein determining the global sensitivity indices comprises identifying a sampling distribution of the plurality of measurement parameters using a measurement parameter range for each measurement parameter; receiving a noise model; and determining the global sensitivity indices using the measurement parameters, the sampling distribution, and the noise model; and rank each measurement channel of the plurality of measurement channels using the global sensitivity indices.

E17. The system of embodiment E16, wherein the processor-executable instructions further instruct the system to receive a selection threshold; and select at least a portion of the plurality of measurement channels based on the selection threshold.

E18. The method of embodiment E16 or E17, wherein selecting the at least a portion of the plurality of measurement channels is performed before drilling the wellbore, during drilling of the wellbore, or after drilling the wellbore.

E19. The method of any one of embodiments E16-18, wherein determining the global sensitivity indices further comprises determining a local sensitivity indices for each measurement parameter of the plurality of measurement parameters.

E20. The method of embodiment E19, wherein determining the local sensitivity indices comprises identifying each measurement parameter range for each measurement parameter; receiving the noise model; and determining the local sensitivity for each measurement parameter of the plurality of measurement parameters using the measurement parameter, the measurement parameter range, and the noise model.

While the present disclosure has been described with respect to a number of embodiments and examples, those skilled in the art, having benefit of this disclosure, will appreciate that other embodiments can be devised which do not depart from the scope and spirit of the present disclosure.

What is claimed is:

1. A method of ranking a plurality of measurement channels, comprising:
receiving a plurality of measurement channels for a logging tool;
determining a plurality of measurement parameters for each measurement channel of the plurality of measurement channels of a formation of a wellbore;
determining a global sensitivity indices, wherein determining the global sensitivity indices comprises:
identifying a sampling distribution of the plurality of measurement parameters using a measurement parameter range for each measurement parameter;
receiving a noise model; and
determining the global sensitivity indices using the measurement parameters, the sampling distribution, and the noise model; and
ranking each measurement channel of the plurality of measurement channels using the global sensitivity indices.

2. The method of claim 1, further comprising:
receiving a selection threshold; and
selecting at least a portion of the plurality of measurement channels based on the selection threshold.

3. The method of claim 2, wherein receiving the selection threshold comprises receiving a user input.

4. The method of claim 2, wherein the selection threshold comprises a weight percent threshold.

5. The method of claim 2, wherein the selection threshold comprises a numerical threshold.

6. The method of claim 2, wherein selecting at least a portion of the plurality of measurement channels based on the selection threshold is performed before drilling the wellbore, during drilling of the wellbore, or after drilling the wellbore.

7. The method of claim 1, wherein determining the global sensitivity indices further comprises determining a local sensitivity indices for each measurement parameter of the plurality of measurement parameters.

8. The method of claim 7, wherein determining the local sensitivity indices comprises:
identifying each measurement parameter range for each measurement parameter;
receiving the noise model; and
determining the local sensitivity indices for each measurement parameter of the plurality of measurement parameters using the measurement parameter, the measurement parameter range, and the noise model.

9. A method of selecting measurement channels, comprising:
receiving a plurality of measurement channels for a logging tool;
determining a plurality of measurement parameters for each measurement channel of the plurality of measurement channels of a formation of a wellbore;
determining a global sensitivity indices using the plurality of measurement parameters and a sampling distribution;
ranking each measurement channel of the plurality of measurement channels using the global sensitivity indices; and
selecting at least a portion of the plurality of measurement channels, wherein selecting the at least a portion of the plurality of measurement channels comprises:
receiving a selection threshold; and
selecting the at least a portion of the plurality of measurement channels based on the selection threshold.

10. The method of claim 9, wherein the selection threshold comprises a numerical threshold.

11. The method of claim 9, wherein determining the global sensitivity indices further comprises determining a local sensitivity indices for each measurement parameter of the plurality of measurement parameters.

12. The method of claim 11, wherein determining the local sensitivity indices comprises:
identifying each measurement parameter range for each measurement parameter;
receiving a noise model; and
determining the local sensitivity indices for each measurement parameter of the plurality of measurement parameters using the measurement parameter, the measurement parameter range, and the noise model.

13. The method of claim 9, wherein selecting the at least a portion of the plurality of measurement channels based on the selection threshold is performed before drilling the wellbore, during drilling of the wellbore, or after drilling the wellbore.

14. The method of claim 13, further comprising selecting the at least a portion of the plurality of measurement channels based on a channel availability or measurement quality.

15. The method of claim 13, wherein disposing the logging tool in the wellbore.

16. A system comprising:
one or more processors;
memory operatively coupled to the one or more processors; and
processor-executable instructions stored in the memory and executable by at least one of the processors to instruct the system to:
receive a plurality of measurement channels for a logging tool;
determine a plurality of measurement parameters for each measurement channel of the plurality of measurement channels of a formation of a wellbore;
determine a global sensitivity indices, wherein determining the global sensitivity indices comprises:
identifying a sampling distribution of the plurality of measurement parameters using a measurement parameter range for each measurement parameter;
receiving a noise model; and
determining the global sensitivity indices using the measurement parameters, the sampling distribution, and the noise model; and
rank each measurement channel of the plurality of measurement channels using the global sensitivity indices.

17. The system of claim 16, wherein the processor-executable instructions further instruct the system to:
receive a selection threshold; and
select at least a portion of the plurality of measurement channels based on the selection threshold.

18. The system of claim 16, wherein selecting the at least a portion of the plurality of measurement channels is performed before drilling the wellbore, during drilling of the wellbore, or after drilling the wellbore.

19. The system of claim 16, wherein determining the global sensitivity indices further comprises determining a local sensitivity indices for each measurement parameter of the plurality of measurement parameters.

20. The system of claim 19, wherein determining the local sensitivity indices comprises:
identifying each measurement parameter range for each measurement parameter;
receiving the noise model; and
determining the local sensitivity indices for each measurement parameter of the plurality of measurement parameters using the measurement parameter, the measurement parameter range, and the noise model.
